(19) United States
(12) Patent Application Publication
(10) Pub. No.: US 2007/0118385 A1
(43) Pub. Date: May 24, 2007

(54) Capturing and utilizing business-to-recipient mailing preferences

(76) Inventor: David Silverstein, Longmont, CO (US)

Correspondence Address: JENNINGS, STROUSS & SALMON, P.L.C., 201 E. WASHINGTON ST., 11TH FLOOR, PHOENIX, AZ, 85004, US

(21) Appl. No.: 11/262,335

(22) Filed: Oct. 28, 2005

(51) Int. Cl. G06Q 99/00

(52) U.S. Cl. 705/1

(57) ABSTRACT

The present invention is directed to a system and method for capturing and utilizing communication preferences of recipients of certain communications, and more particularly to a system and method for providing a recipient or consumer with a single site or single source for selectively choosing which mail, telephone, or email solicitations the consumer would like to receive, the frequency and format of how those solicitations are received, and then eliminating others. The system and method is applicable to a wide variety of mail, telephone and email solicitations including, but not limited to, catalogs, financial and credit card solicitations, personal and professional services solicitations, and store or coupon mailers.

### FIELD OF THE INVENTION

This invention relates generally to a system and method for capturing and utilizing communication preferences of recipients of certain communications, and more particularly to a system and method for providing a recipient or consumer with a single site or single source for selectively choosing which mail, telephone, or email solicitations the consumer would like to receive, the frequency and format of how those solicitations are received, and then eliminating others. The system and method is applicable to a wide variety of mail, telephone and email solicitations including, but not limited to, catalogs, financial and credit card solicitations, personal and professional services solicitations, and store or coupon mailers.

### BACKGROUND OF THE INVENTION

When many Americans open their mail boxes, they find a thick stack of unwanted junk mail. The amount of paper junk mail sent each year in the United States alone exceeds well over four million tons. It is estimated that catalog paper alone exceeds 3.35 million tons. Nearly half of this, or over two million tons, is never even opened by recipients. The average household receives 1,300 pieces of mail per year, of which at least 560 pieces can be classified as junk mail.

U.S. catalog circulation alone topped 18 billion in 2004, averaging out to about 85 catalogs received per person. U.S. direct mail circulation exceeds 100 billion per year. However, the response rate to all these solicitations is approximately only one and a half percent.

Because paper is still the primary medium that enables the catalog and junk mail industry to function, the sheer tonnage of wasted paper is alarming. Even if some of this junk mail is recycled, which is unlikely in the case of financial and credit card solicitations and other mail with personally identifying information, there are still enormous environmental costs associated with the creation and distribution of junk mail.

The paper used to create the high quality glossy paper used for most junk mail and catalogs comes from the harvesting of virgin forests. And in addition to the initial loss of substantial virgin forest inherent in paper waste exceeding four million tons per year, there are also environmental costs associated with the ink, the energy to produce, deliver and recycle the paper and costs associated with recycling inefficiencies.

Beyond the environmental costs, the production and distribution of mass mailings also represents a substantial business cost for the companies generating the material. More often than not companies have little or no information on whether the mailings are targeting the proper consumers or whether the consumers are even interested in their products. Even when businesses have excellent target market data, they often experience a less desirable response rate from consumers. Further, third party mailing lists generate even less desirable results.

Also, business have no way of knowing how often a consumer would like to receive solicitations or the preferred format. For example, some consumers may be more likely to view and place orders from emailed solicitations versus paper ones. Further, companies have no way of knowing whether their mailer contributes to the over 2 million tons of unopened junk mail every year. In 2004 alone, business spent $70 billion dollars on catalog and direct mail expenditures. Ultimately these substantial business costs are passed on to the consumer.

Currently, over 60% of the U.S. population has expressed a desire to receive less junk mail. But presently, in order to deal with unwanted junk mail, the consumers must take numerous, arduous, individualized and uncoordinated actions. For example, for first class mail consumers can cross out the address and bar code, circle the first class postage and write “refused: return to sender.” However, consumers must first be able to recognize that the junk mail is first class. Second, this must be done for every piece of first class junk mail a consumer receives—and this only discourages that particular company from repeat offenses.

A separate action must be taken for bulk mail. The post office throws away bulk mail it cannot deliver, so returning it is ineffective. Under the present available methods for dealing with junk mail, bulk mail is almost impossible to stop because the United States Post Office actively provides addresses, support and encouragement to mailers. Also, a separate action must be taken for credit and financial offers. The major credit agencies all sell aggregate credit information to any bidder. Direct mail and credit companies generate mail based on demographics, including zip code, income band and credit payment patterns. Stopping this mail often requires phone calls to credit agencies and the current creditors of the consumer.

Under the existing methods for dealing with junk mail, catalogs must also be stopped on a company-by-company basis. A consumer must call the company's 800 number and have the label handy for each company from which it receives an unwanted catalog or undertake the arduous task of writing the “do not send” instructions on the mailing label and faxing it to the company. However, this still does not deal with unsolicited mail from companies such as AOL (America On-Line) or Publisher's Clearinghouse Sweepstakes. It has been hypothesized that one could pave the nation with the free discs sent out by AOL to consumers. Each and every one of these companies requires a separate phone call by consumers requesting that they stop sending the junk mail.

Finally, under the present system, after a consumer puts in all this effort, the consumer is still receiving unwanted local business and supermarket fliers. Most consumers do not realize that under postal regulations all mailings must be identified and that each lose-leaf bundle of fliers, by postal regulations, must be delivered at the same time as an address card. In most cases, that card usually has an advertisement and a photograph of a missing child. Even if consumers would figure this out, the consumers would still need to determine the sender, and then call directory assistance to get the phone number of the sender. After completing these arduous tasks, the consumer still must call the sender and ask to be removed from its list.

Therefore, in light of the present uncoordinated, unorganized and arduous methods available for attempting to reduced unwanted junk mail, a need exists for a system and method for providing consumers with a single site or single source for selectively choosing which mail order catalogs and solicitations the consumer would like to receive and eliminating others.

### BRIEF DESCRIPTION OF THE DRAWINGS

FIG. 1 is an illustration of alternate embodiments of the system of the present invention, including Internet, telephone and mail alternatives for capturing consumer preferences.

FIG. 2 is an example of the system in FIG. 1, further including a mechanism for charging the consumer for the mailing preferences service.

FIG. 3 is a flowchart illustrating the steps of the Internet-based account activation of the capture consumer preferences system in which only the merchant is billed.

FIG. 4 is a flowchart illustrating the Internet-based account activation of the capture consumer preferences system in which both subscriber and merchant are billed.

FIG. 5 is a flowchart illustrating the phone account activation of the capture consumer preferences system in which only the merchant is billed.

FIG. 6 is a flowchart illustrating the phone account activation of the capture consumer preferences system in which both the subscriber and merchant are billed

FIG. 7 is a flowchart illustrating the paper-based account activation of the capture consumer preferences system in which only the merchant is billed.

FIG. 8 is a flowchart illustrating the paper-based account activation of the capture consumer preferences system in which both the subscriber and merchant are billed.

FIG. 9 is a flowchart illustrating the general customer service process of the junk mail system.

FIG. 10 is a flowchart illustrating the network partner assessment and performance evaluation process.

FIG. 11 is a flowchart illustrating the catalog and direct mail subscriber preference selection process.

FIG. 12 is a flowchart illustrating the catalog, direct mail, and telemarketing subscriber preference selection process.

FIG. 13 is a flowchart illustrating the catalog, direct mail, telemarketing, and electronic mail subscriber preference selection process.

FIG. 14 is a non-limiting example of primary options in the consumer preference selection module of the disclosed system, showing primary options for the direct mail category.

FIG. 15 is a non-limiting example of secondary options in the consumer preference selection module of the disclosed system, showing secondary options for the direct mail category.

FIG. 16 is a non-limiting example of tertiary options in the consumer preference selection module of the disclosed system, showing tertiary options for the direct mail category.

FIGS. 17A-C illustrate three alternate models of the disclosed system and method.

FIGS. 18A-C illustrate three additional alternate models of the disclosed system and method.

### DETAILED DESCRIPTION OF VARIOUS EMBODIMENTS

The present invention is directed to a system and method for capturing and utilizing communication preferences of recipients of certain communications, and more particularly to a system and method for providing a recipient or consumer with a single site or single source for selectively choosing which mail, telephone, or email solicitations the consumer would like to receive, the frequency and format of how those solicitations are received, and then eliminating others. The system and method is applicable to a wide variety of mail, telephone and email solicitations including, but not limited to, catalogs, financial and credit card solicitations, personal and professional services solicitations, and store or coupon mailers.

The system and method are also capable of notifying potential solicitors and merchants when a consumer is interested in receiving a mail order catalog or other solicitation, and in some instances, automatically generating the appropriate response on behalf of the merchant. Thus, the present system and method is capable of providing solicitors and merchants with a targeted list of interested consumers resulting in a more effective and efficient mail order solicitation program.

Practically, the present system provides a method for consumers for reducing unwanted junk mail and other solicitations received by the consumer, while allowing merchants to more effectively market. Thus, one advantage of the present system and method is providing a consumer benefit of “one-stop” shopping that, at least in one embodiment, is free of charge. A second advantage of the present system and method is providing a benefit to merchants in leveraging consumer intelligence data, which increases sales and allows business resources to be allocated more effectively. Finally, the present system and method provides numerous environmental benefits by reducing the deforestation due to paper used for mailed solicitations.

Before proceeding to a description of the figures, some preliminary connotational matters will be addressed. The term “host server” designates the server on which a “host web site” will be maintained. A host web site comprises one or more web pages, including, but not limited to, the consumer home page, the consumer account page, the catalog, direct mail, telemarketing and email pages. However, it is envisioned that one embodiment of the invention includes only a home page, consumer account page and catalog pages. Other embodiments include a combination of two or more of the following: catalog, direct mail, telemarketing and email pages. In one embodiment, the catalog, direct mail, telemarketing and email pages further comprise pages denoted herein as primary, secondary and tertiary option pages. Each of the primary, secondary and tertiary option pages gives the consumer a further level of consumer preferences or selection options, as is described in detail below.

The terms “host,” “host server,” and “host web site” will be used interchangeably since in one embodiment, the host server is accessed through the Internet or World Wide Web, as a web site. However, a “portal” will be used to refer to a web page or merchant access point on the host web site. The present system and method allow for a merchant to be given, purchase or license a portal on the host web site for its use.

Additionally, while it is recognized that there is a technological distinction between Internet and World Wide Web, the terms are seemingly interchangeable and used as such throughout this description. The use of these terms in this fashion is for descriptive convenience only. The skilled artisan will appreciate that the system encompasses the technological context of both the Internet and the World Wide Web.

Further, reference to “data” or “data storage” will refer to information stored on the “host server” and transmitted, in one embodiment, from a consumer, via the Internet from the consumer's personal computer or other personal electronic device capable of Internet communication. The transmission of data from the consumer may also occur via telephone or hand-written response. The transmission of data from the host server to the businesses is also envisioned to occur via Internet transmission or other secure electronic transmission from the host server to the business' computer server.

The terms “consumer,” “recipient,” “subscriber,” and “customer” will be used interchangeably. Specifically, the terms “consumer,” “subscriber,” “customer,” and “recipient” are used alternately to designate any person, business, or any other entity that receives communications from any other entity, including all types of businesses and organizations. Similarly, “merchant” or “business” will be used interchangeably and will be used herein to designate any entity sending communications that are the subject of the present system and method.

The terms “Non-Network Partner” and “Non-Partner” will be used interchangeably.

Finally, “business-to-recipient communications” according to the present disclosure, means any type of business-to-consumer, business-to-business, or other communications, desired or undesired, including junk mail, received by a consumer. Business-to-recipient communications include, but are not limited to, catalogs, direct mail such as financial and credit card solicitations, personal and professional services solicitations, and store or coupon mailers. According to the present disclosure, the consumer is made aware of the disclosed system and method through print advertisement, advertisement riders to catalogs or other junk mail, Internet advertisements, or by searching the Internet for capture consumer preferences web sites.

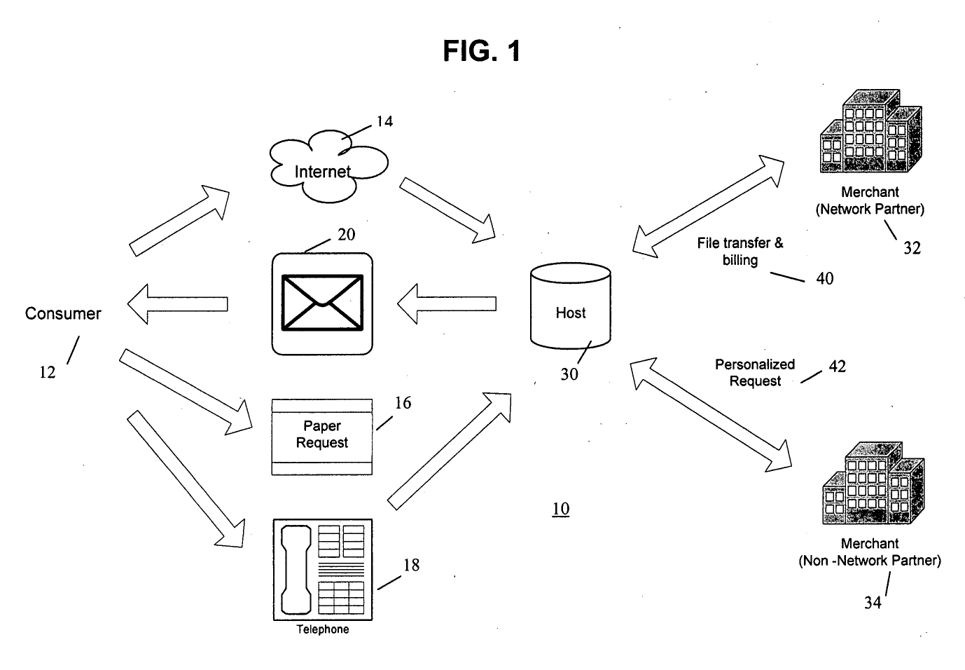

Turning now to the figures, FIG. 1 illustrates one embodiment of a system 10 for carrying our the invention. System 10 includes one or more host servers 30, one or more consumers 12, and one or more merchants, either Network Partners 32 or Non-Network Partners 34, or both. As shown in FIG. 1, the consumer 12 communicates with the host server 30 either directly via the Internet 14, indirectly via hand-written request 16 or indirectly via telephone 18. If the consumer 12 communicates with the host server 30 indirectly, a data entry mechanism, such as scanning, voice recognition or manual data entry, is used to facilitate consumer 12 communication with host server 30.

As shown in FIG. 1, host server 30 receives and stores consumer 12 data. Host server 30 is capable of communicating that consumer 12 data to Network Partners 32 or Non-Network Partners 34 via electronic communication, for example via the Internet or other secured data transfer mechanism. However, it is envisioned that the preferred method will be Internet communication using standard, generally-known data exchange techniques such as the TCP/IP protocol.

As noted above, the host server 30 includes a host web site, for example, the capture consumer preferences web site, stored in unillustrated memory, with the web site including one or more web pages. More specifically, the web pages are formatted and developed using Hyper Text Markup Language (HTML) code. As known in the art, an HTML web page includes both “content” and “markup” portions. The content portion is information that describes a web page's text or other information for display or playback on a computer or other personal electronic device via a display screen, audio device, DVD device or other multimedia device. The markup portion is information that describes the web page's behavioral characteristics, including how the content is to be displayed (e.g., the frame set) and how other information can be accessed (e.g., hyperlinks). Thus the HTML code that marks up formatted web pages of the host web site of one described embodiment displayed in selected, predetermined display regions of a single region of a single computer or other electronic device display screen. It is appreciated that other languages, such as SMGL (“Standard Generalized Markup Language”), XML (“Extensible Markup Language”) DHMTL (“Dynamic Hyper Text Markup Language”), Java, Flash, Quick Time, or any other language for implementing web pages could be used.

The computer or device used by consumer 12 in communicating with the host server 30 are any type of computing device capable of accessing the host server 30 through a host web site via the Internet 14, and capable of displaying the host server's 30 stored web pages using well-known web browser software packages, or any other web browser software. Such computing devices or other electronic devices include, but are not limited to, personal computers (PCs), both IBM-compatible and MacIntosh; hand-held computing devices (e.g., PDAs), cellular telephone devices and web-based telephone sets (e.g., “Web-TV”), collectively referred to herein as the consumer's computer or the computer.

The host server 30 is any type of computer server capable of supporting a web site and web-based management tool. The operating system used to run host server 30 and programming used in implementing the method of one embodiment are stored in unillustrated memory resident with host server 30. The operating system and stored programming used in implementing the method of one embodiment can be any operating system or programming language.

The various hardware and software components of system 10 communicate, in one embodiment, via the Internet 14, to implement the method of the present invention. Although not depicted, Internet 14 access by consumer's 12 computer could be implemented via an Internet Service Provider (ISP), a direct dial-up modem connection, a digital subscriber link (DSL), a dedicated T-1 connection, a wireless local area network connection (WLAN), a cellular signal or satellite relay, or any other communication link.

As shown in FIG. 1, the consumer 12 receives business-to-recipient communications 20. Because consumer 12 has become aware, as described above, of the capture consumer preferences system and method disclosed herein, and desires to stop or limit the receipt of business-to-recipient communications 20 and designate consumer preferences for the receipt of business-to-recipient communications, the consumer 12, via its computer running any of several web browser software packages, accesses the host server 30 via Internet 14.

Specifically, consumer 12 is able to access the provider home page, also referred to herein as the capture consumer preferences home page, of the host web site stored on host server 30 through accessing the capture consumer preferences URL (Uniform Resource Locator). URL access may occur by numerous and varied methods. By way of example, the consumer 12 may type the desired URL directly into the browser. In addition, the consumer 12 may access the URL by selecting a hyperlink displayed on another web site or web page that links the consumer 12 computer to the home page. Hyperlinks displayed on a web page transfer the consumer 12 to a different web site or web page when selected by the consumer 12. The hyperlink to the capture consumer preferences home page may be included as part of an email message displayed by the consumer's 12 computer. The consumer further may access the website from the list of frequently-used sites he or she may have stored as “favorites.” The consumer 12 can also search the Internet 14 for the capture consumer preferences web site using key terms in any Internet search engine such as Google. In any of these examples, when the consumer 12 selects the hyperlink, the consumer 12 computer is directed to the home page. The capture consumer preferences home page is then displayed on consumer's 12 computer screen. Once the consumer 12 has the capture consumer preferences home page displayed, the consumer 12 can begin selecting business-to-recipient communications preferences as described below.

If the consumer 12 does not want to use the Internet 14 to access the host server 30, the consumer 12 completes a hand-written paper request 16, and submits it, for example via mail, or calls via the telephone 18 a designated number, such as a 1-800 number. The particular methods of effectuating data entry for each of these modes of consumer 12 submission of preferences is described in detail below. According to FIG. 1, the consumer 12 is not charged or billed for submitting business-to-recipient communications stop or preference requests to the host server.

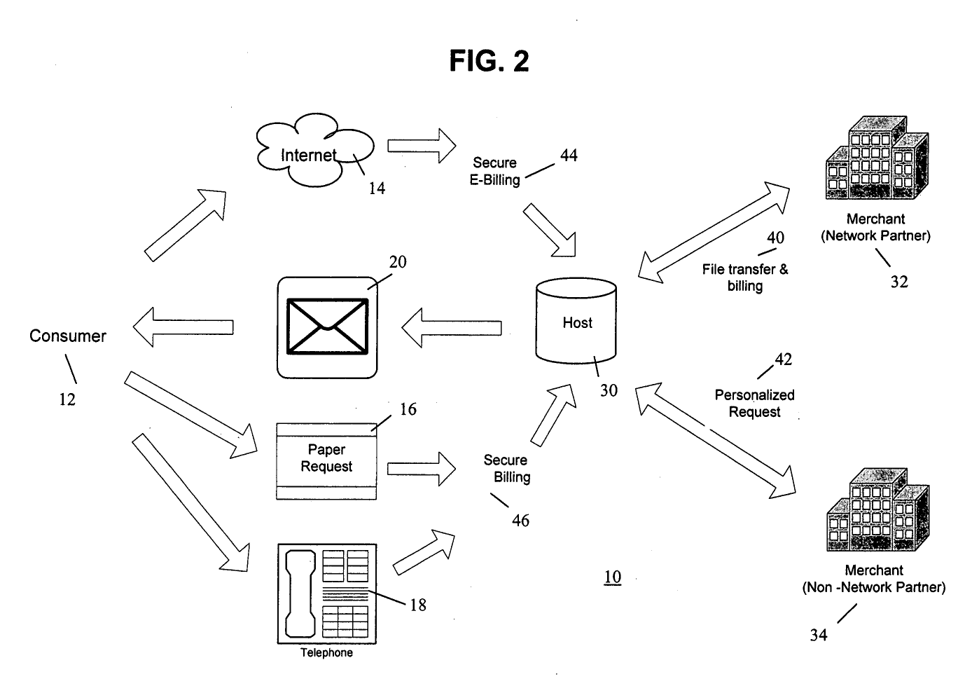

Referring now to FIG. 2, in one embodiment of the invention, when the consumer 12 accesses the host server 30, either directly via Internet 12, or indirectly via mail using paper request 16 or indirectly via telephone 18, the consumer is charged or billed for submitting its capture consumer preferences request or mail preferences request to the host server. According to FIG. 2 the billing or charge is effectuated through secure e-billing 44, or other secure billing 46, such as credit card.

Looking both at FIGS. 1 and 2, once the host server 30 receives the consumer 12 business-to-recipient communications preferences request, the host server 30 processes that data and generates the appropriate response or responses. As described in detail below, if the data relates to a Network Partner 32, the data is transferred, as described above, to Network Partner 32, in step 40. Also, in one embodiment, in step 40, the Network Partner 32 is billed for receipt of the data according to a predetermined billing scheme and depending on the data received. However, if the merchant is a Non-Network Partner 34, the host server 30 generates an appropriate response, for example, a personalized request, in step 42, for the Non-Network Partner to stop sending the particular business-to-recipient communications 20 identified by the consumer 12 when consumer 12 made its business-to-recipient communications stop requests.

According to the present disclosure of the system and method, Non-Network Partner personalized requests to stop sending particular business-to-recipient communications 20 identified by a consumer are effectuated by a variety of methods. For example, personalized requests can either be made through mailed requests or telephone requests to the particular merchant or to a centralized address or number for certain types of business-to-recipient communications.

Non-limiting examples of these requests, depending on the consumer-selected mailing preferences, include sending a written request on behalf of particular consumers requesting to stop ADVO (the missing children fliers) to Consumer Assistance, POB 249, Windsor, CT, 06095-4176; sending a written request to stop receipt of Val-Pak Coupons to 1661 Worchester Road, Framingham, Mass. 01701; sending a written request to Mail Preference Service, Direct Marketing Association, POB 643, Carmel, N.Y., 15021-0643, to stop many national mailings of their member organizations; sending specific requests to stop catalogs to the respective merchants' customer service departments; and calling 1-888-5-OPT-OUT on behalf of the consumer for credit cards and financial institutions who are not network partners. According to the present disclosure, a particular procedure is implemented for each consumer mailing preference merchant that is listed as a possible selection.

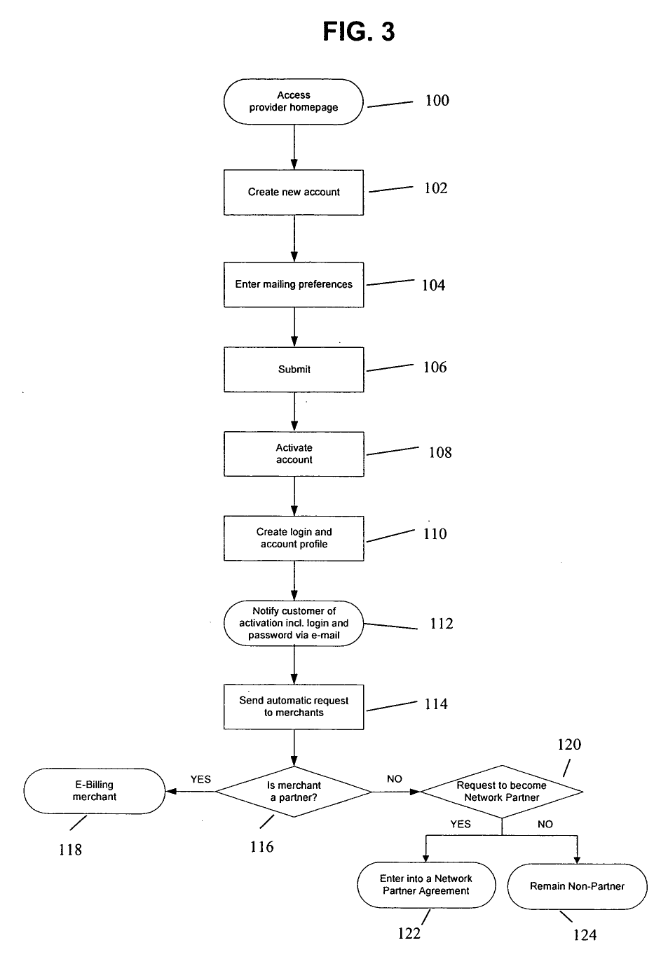

In FIG. 3, a consumer accesses a provider home page in step 100. In step 102, the consumer creates a new account by selecting new account setup and following the instructions on how to create a new account. In step 102, for a new account, the consumer may be required to enter data, such as name, address, email, and telephone number. Additional information may be required, including, but not limited to, billing data, and billing contact information, in the case of e-billing for the services as shown in FIG. 2.

Once the new account is set up, in step 104, the consumer enters its business-to-recipient communications preferences, also referred to herein as junk mail preferences or requests, and described in more detail below. In step 106, the consumer submits the mailing preferences to the host server for processing. In step 108, the host server activates the account and in step 110, prompts the consumer to create a login and account profile. Although not shown, consumer data entry and submission are automatically checked by the host server. If the reviewing or processing of any consumer submission does not comport with the data submission requirements, the host server will return a rejection and/or prompts with suggestions for correct submissions. Following successful review and processing of the consumer submission in step 112, the consumer (now customer) is notified of activation and sent the selected login and password via email.

In step 114, the host server sends an automatic request to each merchant implicated by the consumer mailing preference selections. The host server, in step 116, determines whether the merchant is already a Network Partner or is a Non-Network Partner. If the merchant is a Network Partner, the consumer information and associated mailing preferences are sent to the Network Partner, in step 118, and the Network Partner is billed for that information in accordance with a predetermined billing scheme.

It is envisioned that the predetermined billing scheme is memorialized in some type of network contract or other agreement. It is envisioned that the agreement will consist of requirements for the Network Partner to cease sending business-to-recipient communications to those consumers who have selected not to receive mail from that Network Partner. It also is envisioned that the agreement will consist of charging the Network Partner for the name, address, and specific preferences of each consumer who has elected through the disclosed system to receive mail from that Network Partner.

If in step 116, the merchant is a Non-Network Partner, the host server will first generate a solicitation to that merchant to become a Network Partner in step 120. The solicitation is envisioned to include the cost savings and environmental benefits of eliminating unwanted business-to-recipient communications while cost-effectively targeting consumers who have expressed a specific desire to receive mail from that particular merchant. If in step 122, the merchant elects to enter into the Network Partner Agreement, described above, the merchant become a Network Partner and is billed, as in step 118.

If the merchant elects not to become a Network Partner, in step 124, the merchant is sent an appropriate request to stop sending business-to-recipient communications to those consumers who have indicated the preference not to receive business-to-recipient communications from that merchant. However, it is envisioned that non-network partners will not receive consumer information of consumers who have indicated a desire to receive mail from that merchant.

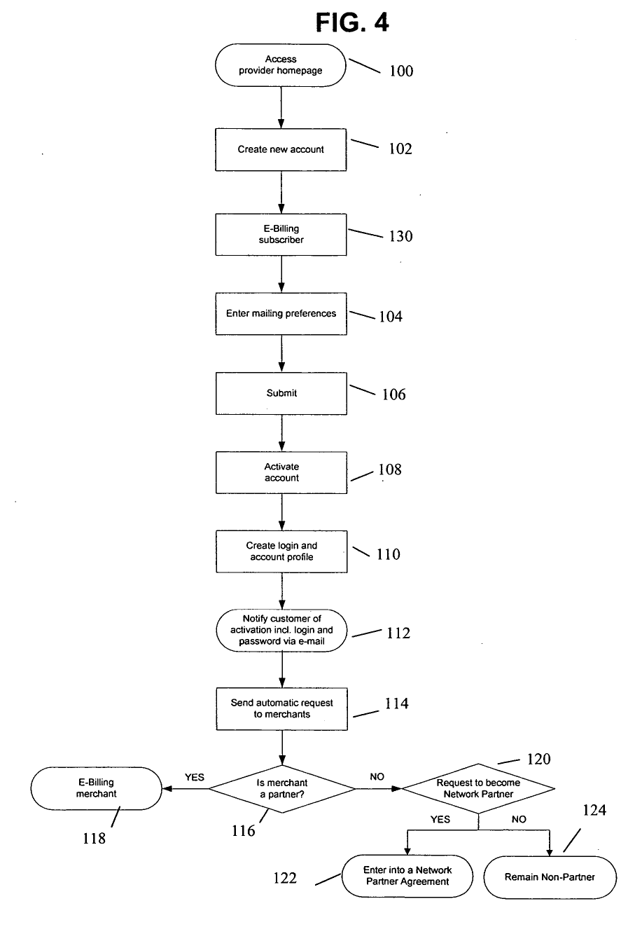

FIG. 4 illustrates the same Internet-based embodiment of the present system and method described in FIG. 3 with the added feature of billing the consumer for providing the mail preferences selection service described herein. In step 130, the consumer is billed, for example via secure e-billing, for the service. Secure e-billing can either be through a service, such as Paypal, or by entering credit card information and submitting it securely to the host server.

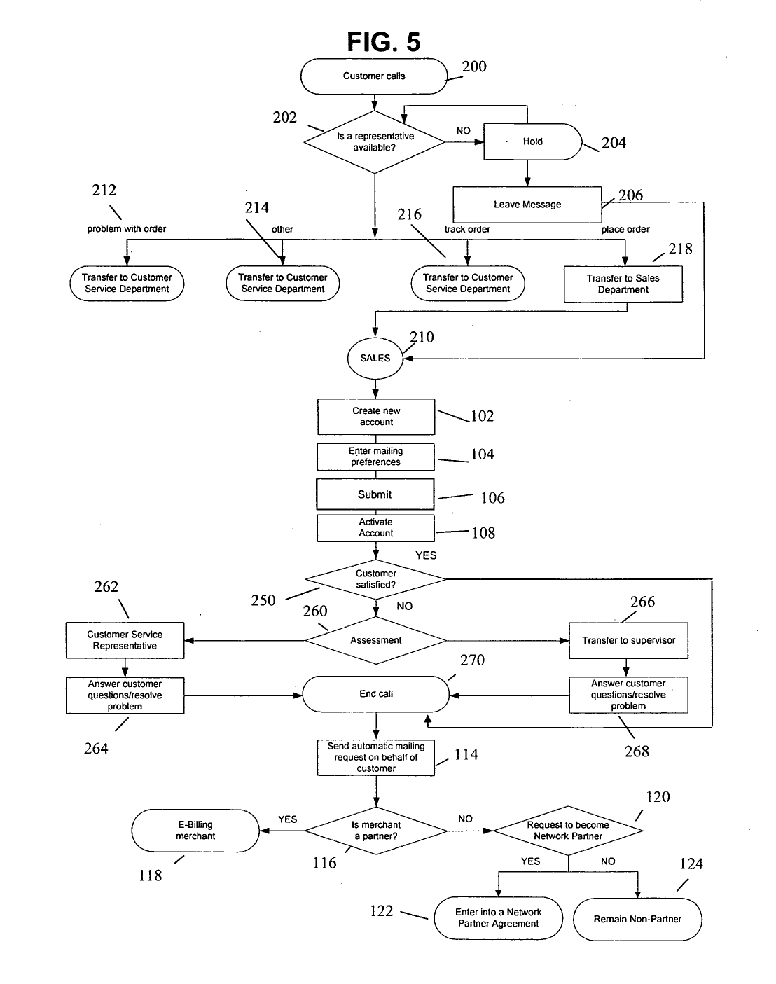

FIG. 5 illustrated the telephone method of entering consumer mailing preferences into the host server. In step 200, the consumer calls, for example, a 1-800 number, and in step 202, the telephone system answers and determines if a representative is available. If a representative is not available, in step 204, the consumer is put on hold, and has the option of leaving a message in step 206. In one embodiment, it is envisioned that the message will be sent to the sales department and that the consumer will be called back by a sales representative. It also is envisioned that instead of leaving a message, the consumer will have the option of completing the sales process in step 210 through voice-recognition software which will execute steps 102 through 108 and interface with the host server in such a way that the information provided by the consumer via the telephone will be entered as data into the host server.

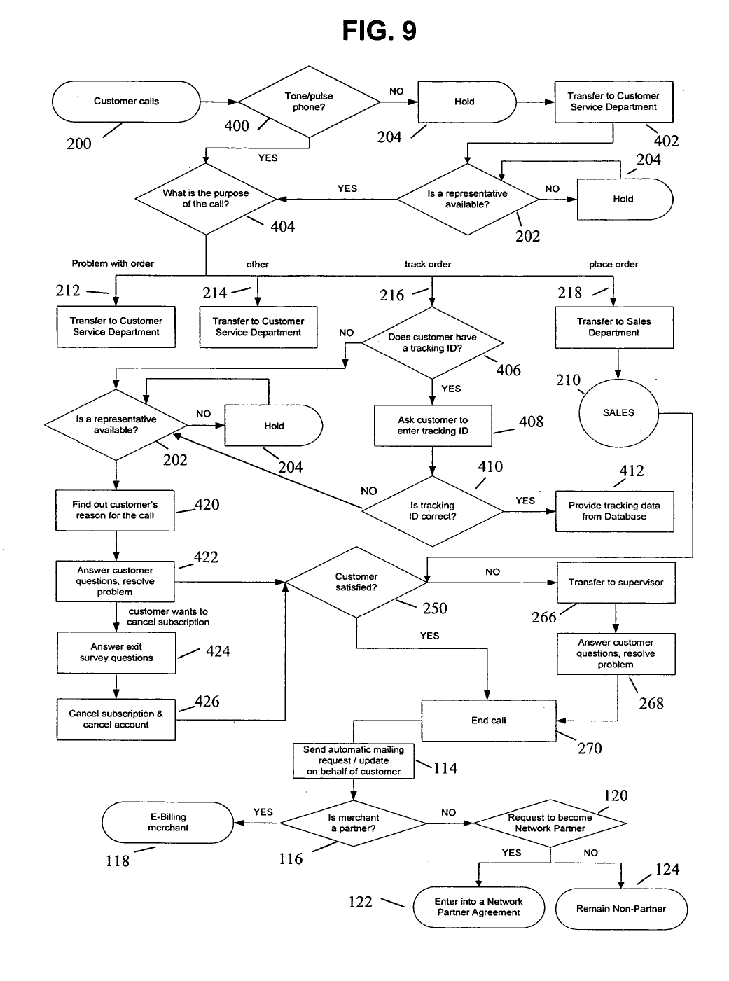

If a representative is available in step 202, the consumer is given certain predetermined options, such as selecting “problem with order” in step 212, “track order” in step 216, “place order” in step 218, or “other” in step 214. If problem with order, track order or other is selected, the consumer is transferred to the customer service department, as shown in steps 212 through 216. The customer service department handles the track order step as described below with reference to FIG. 9.

If the consumer selects “place order” in step 218, the consumer is transferred to the sales department and a representative initiates the sales process in step 210. The sales process in step 210 mirrors the Internet mail preferences selection process in FIG. 3, except that instead of the consumer directly creating a new account and entering the mail preferences, submitting and activating its own account (steps 102 through 108), the data entry is facilitated by a customer service representative. It also is envisioned that voice-recognition software can be used in lieu of a sales representative to execute steps 102-108. As described above, the voice recognition software is interfaced with the host server to allow the voice responses of the consumer in steps 102-108 to be translated into data and entered into the host server without need for a human customer service representative to manually enter the data into the host server.

In step 250, the consumer is given the option, either from the customer services representative or from an automatic prompt, to select that they are satisfied. If the consumer is satisfied, the call is ended in step 270. If the consumer is not satisfied, an assessment is performed in 260. If in step 260 the consumer had previously been speaking only in response to prompts and to the voice-recognition software system, the consumer is directed, in step 262, to a customer service representative, who in step 264, answers the consumer's questions or resolves any problems, and then the call is ended in step 270. If in step 260, the assessment is made that the consumer was already speaking with a customer service representative, the call is transferred to a supervisor, in step 266, who, in step 268, answers the consumer's questions or resolves any problems, and then ends the call in step 270. Once the call is ended, the process continues in steps 114 through 124, as described above in FIG. 3.

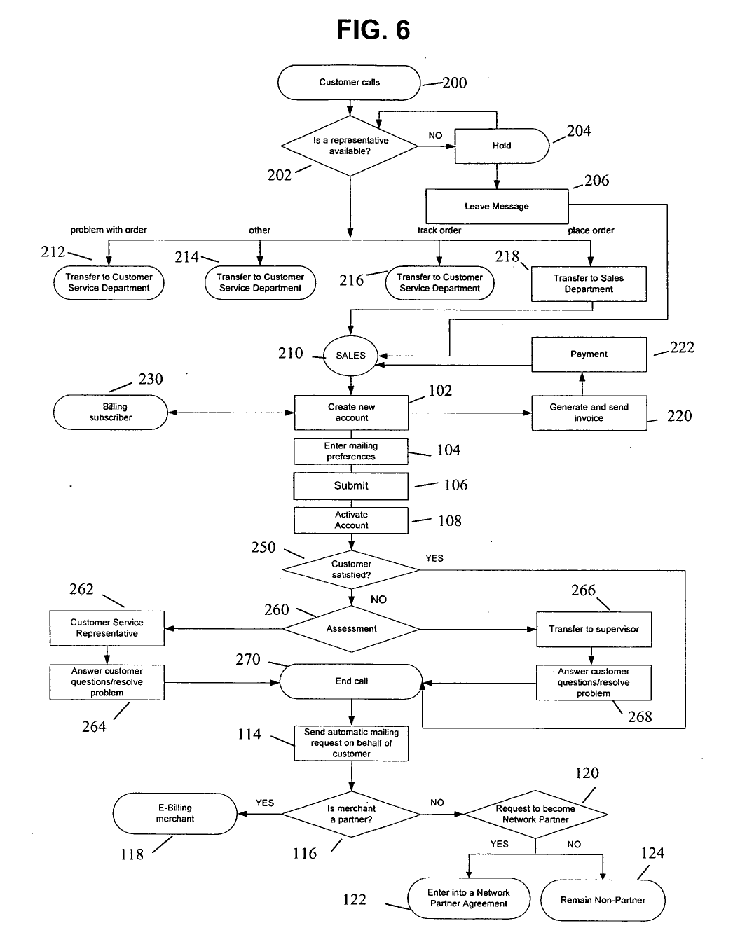

FIG. 6 illustrates the same telephone-based embodiment of the present system and method described in FIG. 5 with the added feature of billing the consumer for providing the mail preferences selection service described herein. In step 230, the consumer is billed, for example by giving the customer service representative or entering into the system via the telephone key pad, his or her credit card information. The consumer may also be billed via e-billing or being sent a paper bill for the service.

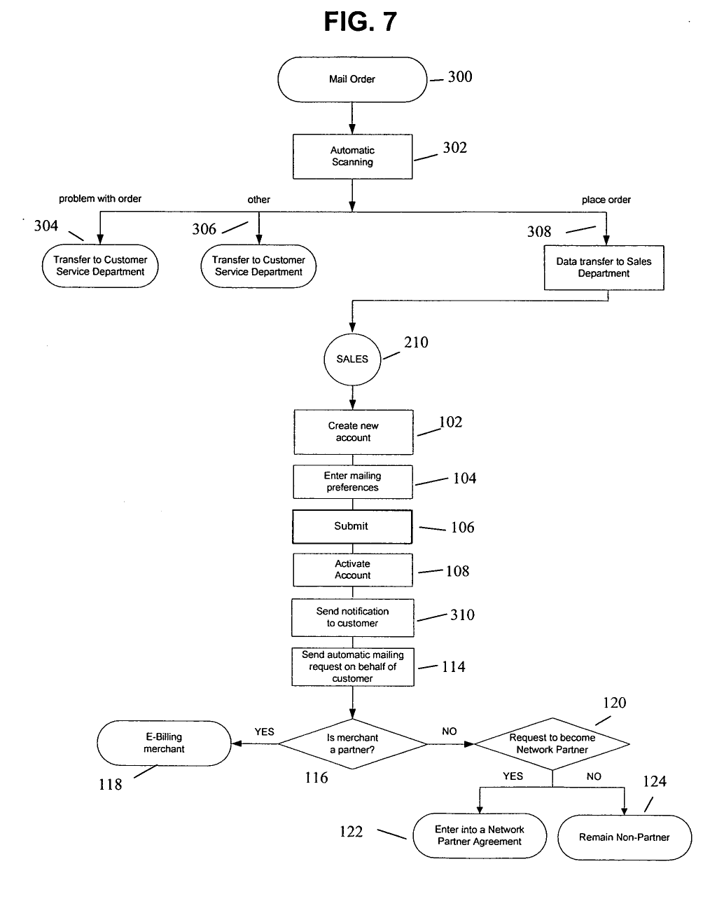

FIG. 7 illustrates the mail or paper-based embodiment of the present system and method. In step 300, the consumer submits via mail or other mechanism, such as facsimile, a paper request containing the same or similar information as is requested in the Internet-based method, described above. For example, the paper-based request will ask for consumer information such as name, address, telephone number, and then have a sheet listing the same or similar mail preference selection choices as are on the Internet-based form. The consumer will then check the mailing preferences it desires and submit the form, as noted in step 300.

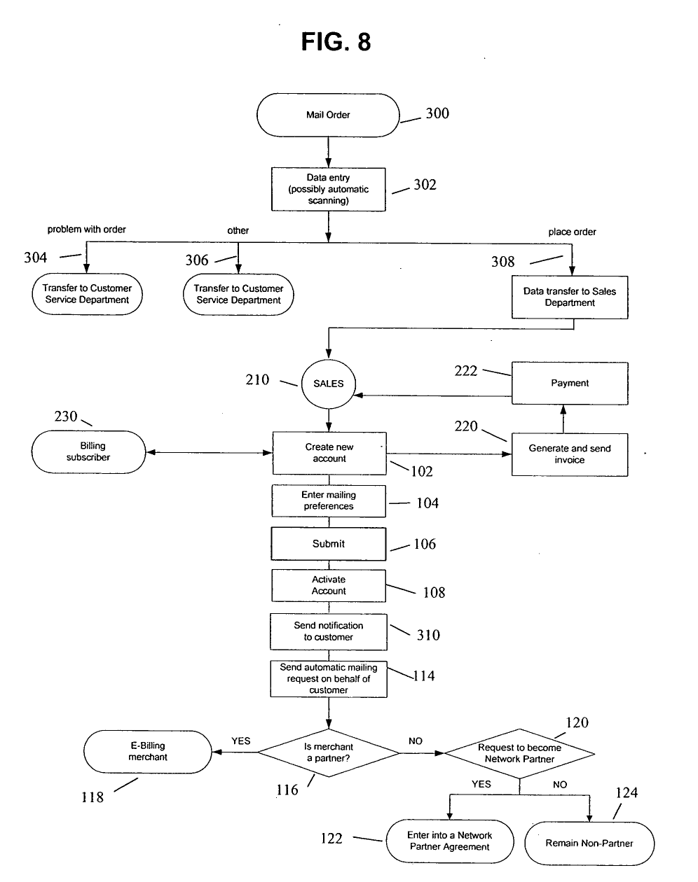

Once the paper-based request is received, the data contained on the form will be entered into the host server, in step 302 (FIGS. 7 and 8). As shown in FIGS. 7 and 8, in step 302, the data can either be entered manually into the same Internet-based form as is used by the consumer in FIG. 3. In the alternative, the data can be entered into the system by scanning the form into the system, wherein the system contains software that will translate the information provided on the paper-based form into data that is entered into the host server. Several known examples of such scanning software and scannable forms are known in the art, such as standardized test scantron forms and readers.

If the paper-based request or any written correspondence from the consumer indicates that there is a problem with the order (step 304) or other problem (step 306), the paper-based request is transferred to the customer service department in steps 304-306. In the embodiment in which manual data entry into the Internet-based form is used, a paper-based request only desiring to place an order for mailing preferences is sent to the sales department or other data entry department in step 308 for entry into the system.

The sales process in step 210 mirrors the Internet mail preferences selection process in FIG. 3, except that instead of the consumer directly creating a new account and entering the mail preferences, submitting and activating its own account (steps 102 through 108), the data entry is facilitated by manual data entry or scanning in the form, as discussed above. As described above, the scanning software is interfaced with the host server to allow the voice responses of the consumer in steps 102-108 to be translated into data and entered into the host server without need for a human customer service representative to manually enter the data into the host server. Once the account is activated in step 108, the consumer is notified via mail or email, depending on the information provided by the consumer, and the process continues in steps 114 through 124, as described above in FIG. 3.

FIG. 8 illustrates the same paper-based embodiment of the present system and method described in FIG. 7 with the added feature of billing the consumer for providing the mail preferences selection service described herein. In step 230, the consumer is billed, for example by entering into the system the consumer's credit card information provided on the paper-based request. The consumer may also be billed via e-billing or being sent a paper bill for the service, as shown in steps 220 and 222, where an invoice is generated and sent to the consumer and payment is received.

FIG. 9 illustrates the general customer service process of the disclosed system and method. In step 200, the consumer calls, for example, a 1-800 number, and in step 400, the telephone system answers and asks if the consumer is calling from a touchtone phone. If not, in step 204, the consumer is put on hold and transferred to a customer service representative in step 402. In step 202, if a customer service representative is not available, the consumer is again put on hold in step 204 until a customer service representative is available.

If in step 400, the consumer has a touchtone phone, the consumer is transferred to an automated telephone prompt system with or without voice recognition technology. The consumer will be prompted to select one of the options in steps 212-218. If the consumer selects “place order” in step 218, the consumer is transferred to the sales department and a representative initiates the sales process in step 210.

The sales process in step 210 mirrors the Internet mail preferences selection process in FIG. 3, except that instead of the consumer directly creating a new account and entering the mail preferences, submitting and activating its own account (steps 102 through 108), the data entry is facilitated by a customer service representative. If the consumer selects to place an order in step 218, one embodiment envisions that the consumer will have the option of completing the sales process in step 210 through voice-recognition software, which will execute steps 102 through 108 and interface with the host server in such a way that the information provided by the consumer via the telephone will be entered as data into the host server.

If “track order” in step 216, is selected, the consumer is asked in step 406 whether the consumer has a tracking number or other identification number for its previous mailing preferences request. If the consumer does, the consumer is prompted, in step 408, to enter a tracking or other identification number, such as account number, for the consumer's previous mailing preferences request. In step 410, the system then verifies that the tracking or other identification number is correct. If the tracking number is correct, in step 412, the system provides the tracking data from a pre-established database.

If the consumer either does not have a tracking number, or the tracking number is not correct, the consumer is then transferred to a customer services representative in step 202 and if a representative is not available, the consumer is put on hold in step 204 until one is available. Once a customer service representative answers the call, the customer services representative finds out the consumer's reason for calling in step 420. The customer service representative then answers the consumer's questions or resolves the customer's problem in step 422. If in step 422, the consumer wants to cancel its subscription, the customer service representative ask the consumer to answer exit survey questions in step 424. If the consumer still wants to proceed with canceling the subscription and its account, the customer service representative does so in step 426.

In step 250, the consumer is given the option, either from the customer services representative in step 422 or from an automatic prompt after the customer service representative cancels the consumer's subscription in step 426, to select that they are satisfied. If the consumer is satisfied, the call is ended in step 270. If the consumer is not satisfied, the call is transferred to a supervisor, in step 266, who, in step 268, answers the consumer's questions or resolves any problems, and then ends the call in step 270. Once the call is ended, the process continues in steps 114 through 124, as described above in FIG. 3.

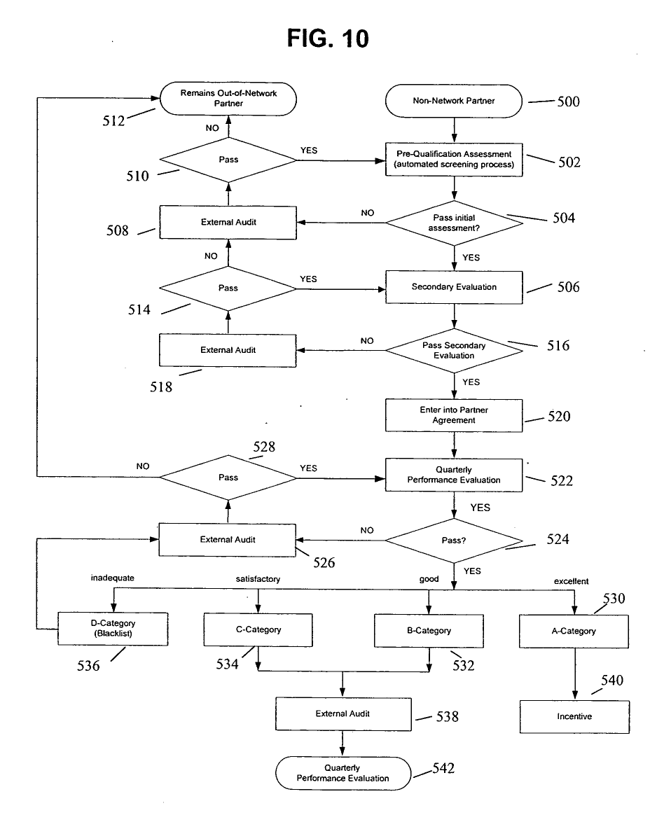

FIG. 10 illustrates the network partner enrollment, assessment and performance evaluation process. In step 500, all merchants begin as non-network partners. In step 502, the non-network partners are subjected to a pre-qualification assessment. In one embodiment this is an automated screening process. If the non-network partner passes the initial pre-qualification assessment in step 504, in one embodiment, the non-network partner is subject to a secondary, more in-depth evaluation in step 506.

However, if the non-network partner does not pass the initial pre-qualification assessment, an external audit of that evaluation is conducted in step 508. If the non-network partner passes the external audit in step 510, the non-network partner then proceeds to the secondary evaluation in step 506. If the non-network partner does not pass the external audit in step 510, the merchant remains an out-of-network or non-network partner in step 512. Further, if the non-network partner does not pass the secondary evaluation in step 516, an external audit is conducted in step 518. If the non-network partner does not pass the external audit, the merchant remains a non-network partner in step 512.

If in step 516, the non-network partner passes the second evaluation, the non-network partner is asked in step 520 to enter into the Network Partner agreement discussed above. One embodiment of the present system and method envisions that quarterly or other periodic evaluation of the network partners will be conducted in step 522. If the network partners do not pass the quarterly inspection in step 524, an external audit will be conducted in step 526, and if the network partner does not pass the external audit in step 528, the network partner will return to non-network status in step 512.

As part of the quarterly evaluation, in one embodiment, the network partner will receive a rating or grade, for example “A,” “B,” “C,” or “D” or excellent, good, satisfactory or inadequate, as shown in steps 530-536. A grade of anything but “A” or excellent (steps 532-536) prompts an external audit as illustrated in steps 526 and 538, with reevaluation at the next performance evaluation (step 542). A grade of “A” or excellent results, in one embodiment, in an incentive (step 540).

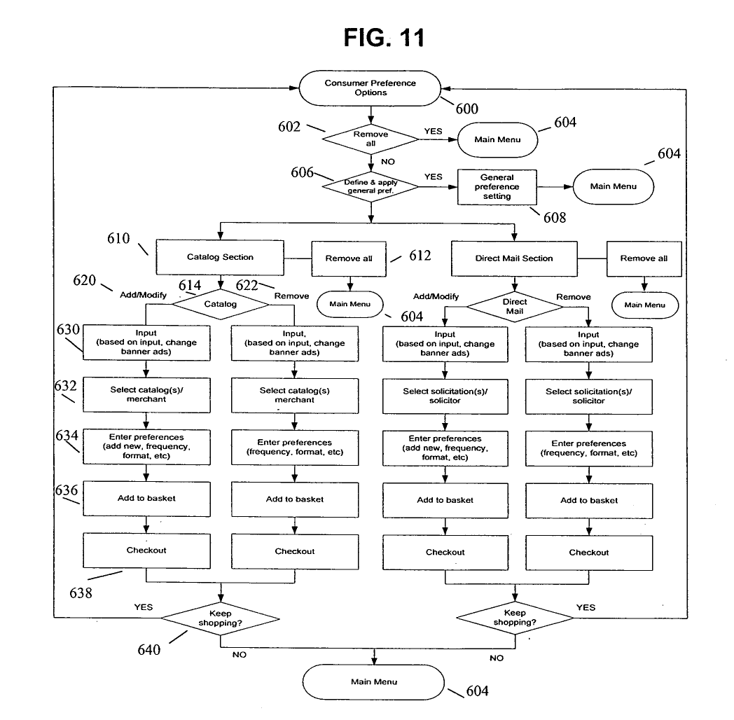

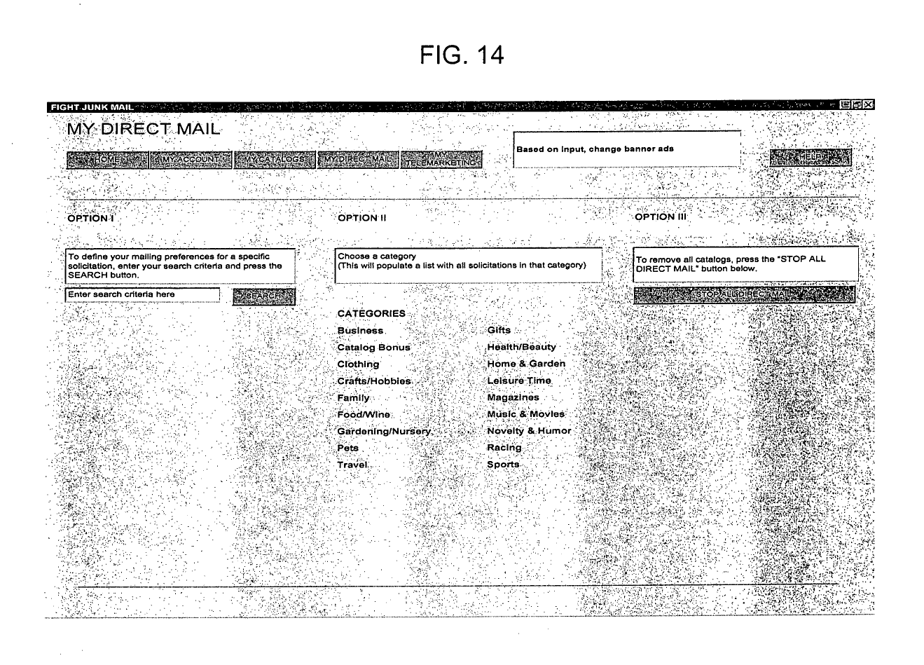

Now viewing FIGS. 11-13 in combination with the screen shots in FIGS. 14-16, the consumer mailing preferences selection module of the disclosed system and method is described in detail. Prior to step 600 in FIG. 11, the consumer has already activated its account as illustrated in the description of FIG. 3, for example under the “My Account” tab shown in FIG. 14. The first set of choices, for example, Options I, II and III, as shown in FIG. 14, are defined herein as primary options.

Under the consumer preferences options in step 600, the consumer has the first primary option of removing all business-to-recipient communications in step 602. This is shown as “Option III” in FIG. 14. If “remove all” is selected, all merchants, including all catalog, direct mail, and any other category of merchant listed on the host web site, are notified to stop sending mail, as illustrated in FIG. 3, and the consumer is returned to the main menu as shown in step 604.

A second primary option, as shown in step 606, allows the consumer to define and apply general preferences and set those in step 608. The general preferences, for example, may include, but are not limited to, removing all direct mail solicitations, but not all catalogs, removing all business solicitations and catalogs; removing all catalogs except gardening/nursery catalogs, or some other generalized preference. If the consumer only desires to set general preferences in step 608, the consumer is then returned to the main menu in step 604. General preferences can also be effectuated by executing steps 610-612, for example, in FIG. 11. In step 610 the consumer selects the “my catalogs” tab (as shown in FIG. 14) and is allowed in step 612 to remove all catalogs, and then is returned to the main menu in step 604.

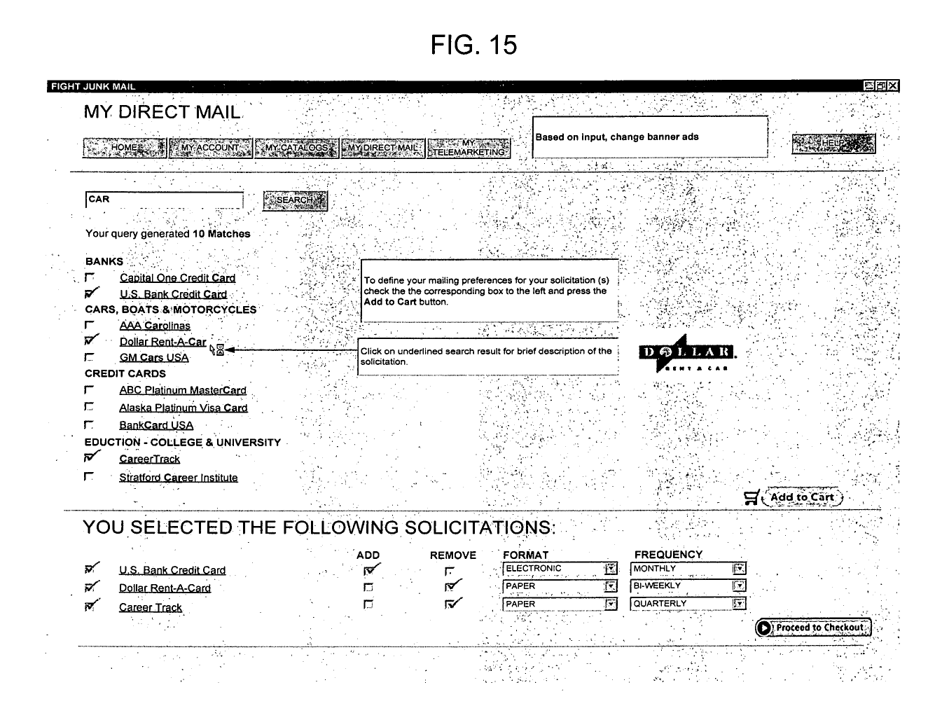

A third primary option, shown as “Option II” in FIG. 14, is to select a general category, such as business, clothing, gardening, or any other pre-designated category, more non-limiting examples of which are shown in FIG. 14. Once a category is selected by the consumer, if the consumer does not “remove all” from that category, the consumer views all catalogs or merchants for that particular category. At this stage, the consumer has a secondary level of options, namely to choose particular catalogs or merchants from the particular category selected that he or she would either like to “add” or “remove” from mailing preferences, thereby instructing the system to either stop that business-to-recipient communications or notify the merchant to send it the selected business-to-recipient communications. Examples of secondary options are shown in FIG. 15.

A fourth primary option, as shown in FIG. 14 as “Option I,” is to search for and select a specific merchant, catalog or key word to either receive or stop receiving. FIG. 15 illustrates results returned under Option I for the key word “car.” This allows the consumer to deselect specific business-to-recipient communications that it has received or, in the alternative, to select specific business-to-recipient communications it would like to receive. For example, in step 610, the consumer would select the “my catalogs” tab (as shown in FIG. 14), search for the specific catalog or merchant in step 614 and then either add the catalog in step 620 or remove the catalog in 622.

The add and remove functions are accomplished through a series of steps 630-638. In step 630, the consumer inputs the catalog or merchant name or, as shown in FIG. 15, a key word or search term. In step 630, it is envisioned that the system and method contain a function that displays advertisements, such as banner ads or other pop-up advertisements, based on the consumer entry in step 630. The advertisements are either directly related to the entry, competitors of the entry or are shown based on other pre-programmed logic, or even at random.

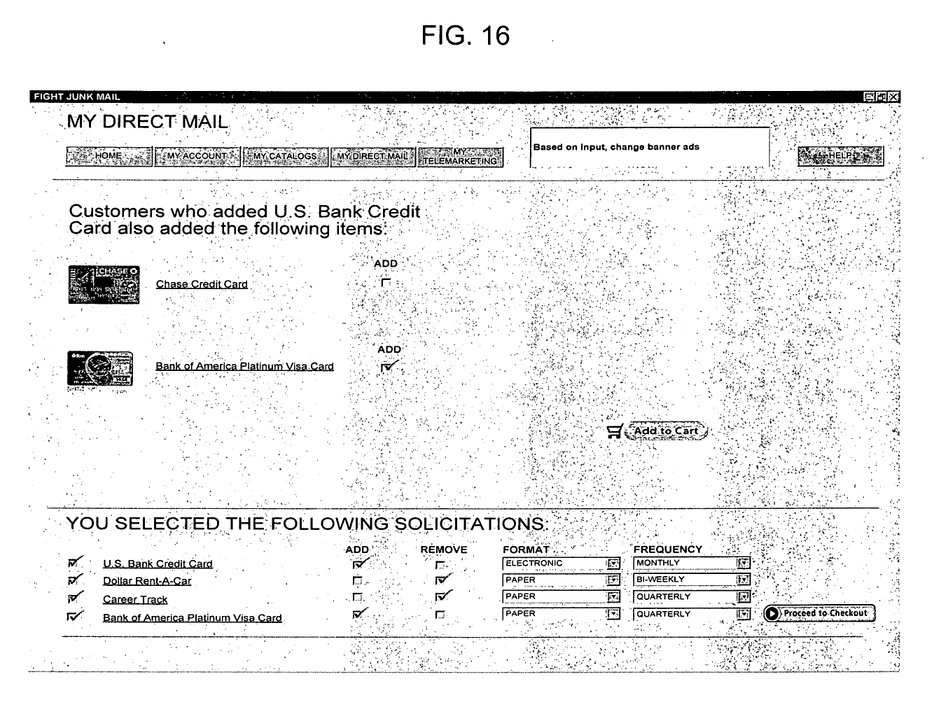

In step 632, the consumer selects or removes one or more merchants or catalogs as shown in FIG. 15. Once a consumer has exercised certain secondary options, the consumer is given an opportunity to also exercise a tertiary set of options with respect to an individual catalog or merchant. As shown in FIG. 16, and described in step 634 in FIG. 11, the consumer can enter preferences such as frequency and format of mailed solicitations it has elected to add or receive. Once the consumer has finished making all selections, as shown in FIG. 16, the consumer then adds the selections to a “cart” or “basket,” as shown in FIG. 16 and as described in step 636 in FIG. 11. Finally, the consumer can “checkout” in step 638 (also shown in FIG. 16) and is given the option to keep shopping, in step 640, or return to the main menu (step 604).

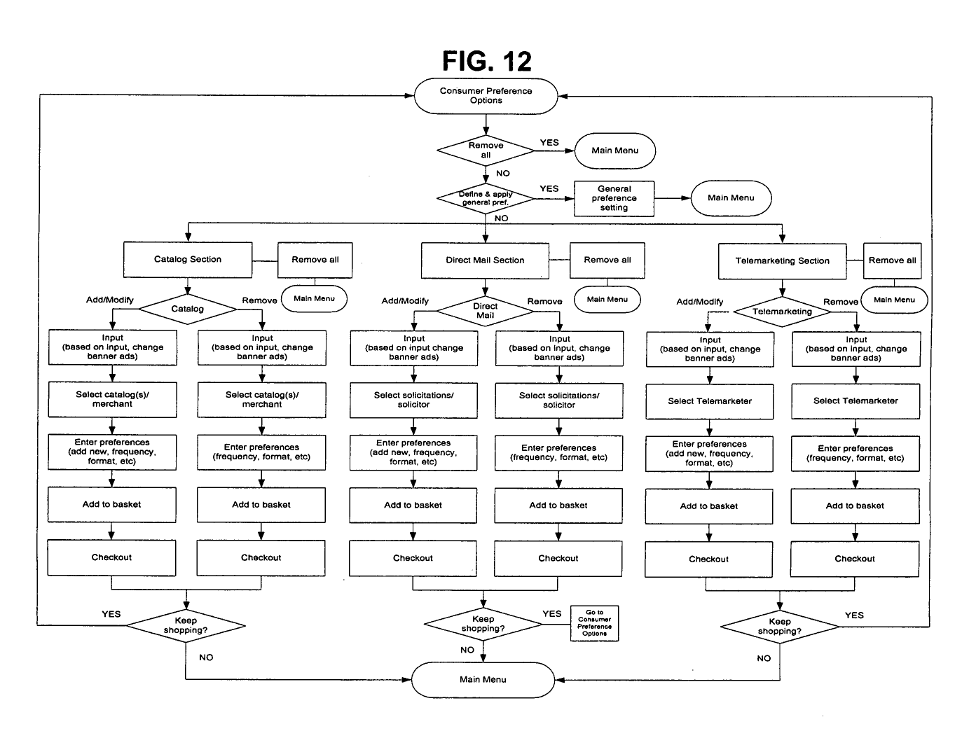

FIG. 12 illustrates the addition of a telemarketing option for the consumer to remove all telemarketers, in which case, in one embodiment, the system adds the consumer to the national “Do Not Call” registry. However, if the consumer elects specific preferences for certain telemarketers to call, the system adds the consumer to the national “Do Not Call” registry and then specifically authorizes certain selected merchants, on the consumer's behalf, to contact the consumer.

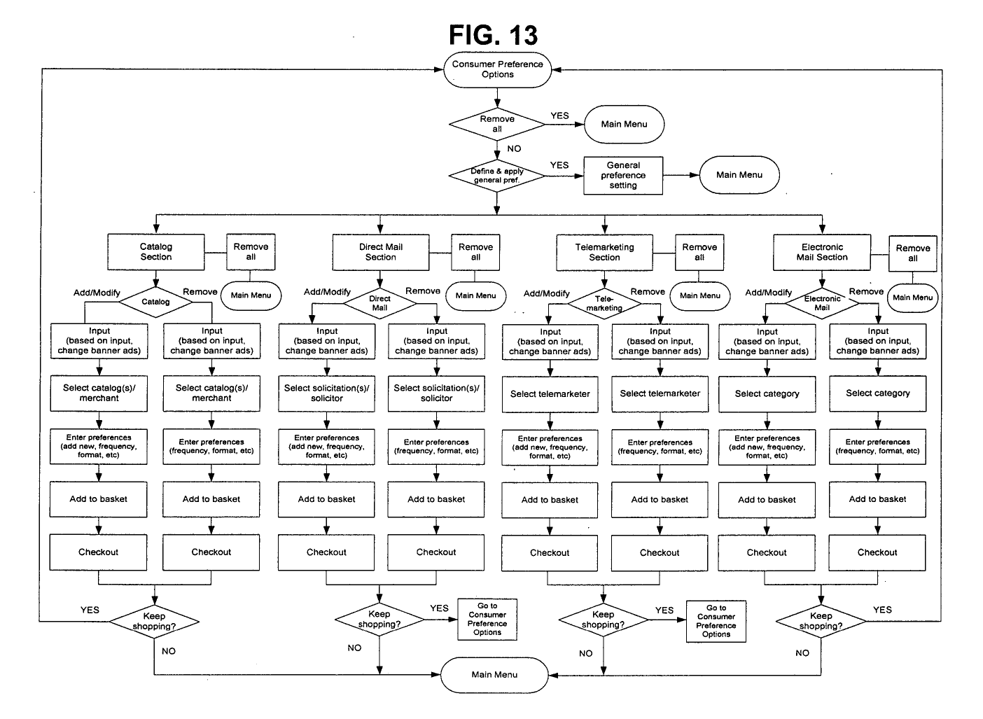

Finally, FIG. 13 further includes an electronic mail selection process, also with an option to remove all electronic business-to-recipient communications. One embodiment of the electronic business-to-recipient communications system and method for filtering junk email messages is envisioned as follows and is by way of enabling example only. According to one embodiment, all email messages are redirected from one or more client, resident servers to a separate server(s), which will serve as an email “clearing house.” All incoming email messages that are received by the “clearing house server” will be filtered based on the rules that are set forth below, and those emails that pass that filtering process are then directed to the particular client's resident server and on to the intended email recipient.

Under one embodiment of the idea, software that is employed by the clearing house server will cause the intended email recipient to periodically receive a “filtering report” from the clearing house, which for each filtered email during that period, will succinctly list the email address of the sender, a predetermined number of characters contained in the subject line of the filtered email, and/or a predetermined number of characters from randomly generated portions of the email. By clicking on an icon from “filter report,” the email recipient can retrieve the filtered email.

Under an extension of that idea, software will be utilized that will prioritize the emails in the filter report based the determined confidence level that the email is business-to-recipient communications (factors will include whether the email address or domain name is on a personal or universal block list, the domain name is from hotmail or a generic email account provider, from a foreign country, etc.). Under another embodiment of the idea, those emails that do not pass the filtering process will be sent to a “filtered” folder for the specifically named email recipient. Under a third embodiment of the idea, a failure to pass the filtering process will cause the clearing house server to query the sender of the email to confirm that the email message is not a business-to-recipient communication.

A dynamic database of email addresses that do not send business-to-recipient communications will be created through a constant series of steps (“the Universal Spam Free Database”), and emails will be filtered if they are not in the Universal Spam Free Database or if they are in the Universal Spam Block List. The Universal Spam Free Database will be created by first loading the addresses of each client's pre-approved specific email addresses and domain names that the client will permit email messages to pass on their resident server. Each client will be prescreened to ensure that it does not disseminate junk email.

Next, the email addresses of each client will be added to the Universal Spam Free Database. Finally, each time a client sends an email to someone, the email address of the recipient will be added to the Universal Spam Free Database, unless that address is on the “Universal Spam Block List”. A Universal Spam Block List of email addresses and/or domain names (domain names of email providers, e.g., Hotmail, will not be added to the list) that are known to send junk email will be created.

Under one embodiment of the idea, software will be utilized that will permit a limited number of predetermined individuals from each client to have the authority to click a button on their email viewer software, which will delete any incoming email message and transmit the email message to the clearing house server for possible addition to the Universal Spam Block List, based on series of rules.

Under another embodiment of the idea, software will be utilized that will permit each user to have the option of creating a personal business-to-recipient communications block list, where any emails that are from specific email addresses or domain names on that list will be deleted and sent to the clearing house server. The Universal Spam Block List will be increased by some of the entries in each user's personal spam block list based on statistical protocol used by the software that manages the clearing house server.

Under another embodiment of the idea, each client will have the option of utilizing either the Universal Spam Free Database, or utilizing a client specific database or spam free database, which is created by, at the client's option, (i) utilizing some or all of the Universal Spam Free Database, (ii) utilizing some or all of the Universal Spam Block List, (iii) having the client provide an approved list of email addresses and domain names from which it wishes to receive email messages, (iv) creating a client specific junk email “block” list, and/or (v) adding to the client's spam free database any of the client's users' emails that are sent through the clearing house.

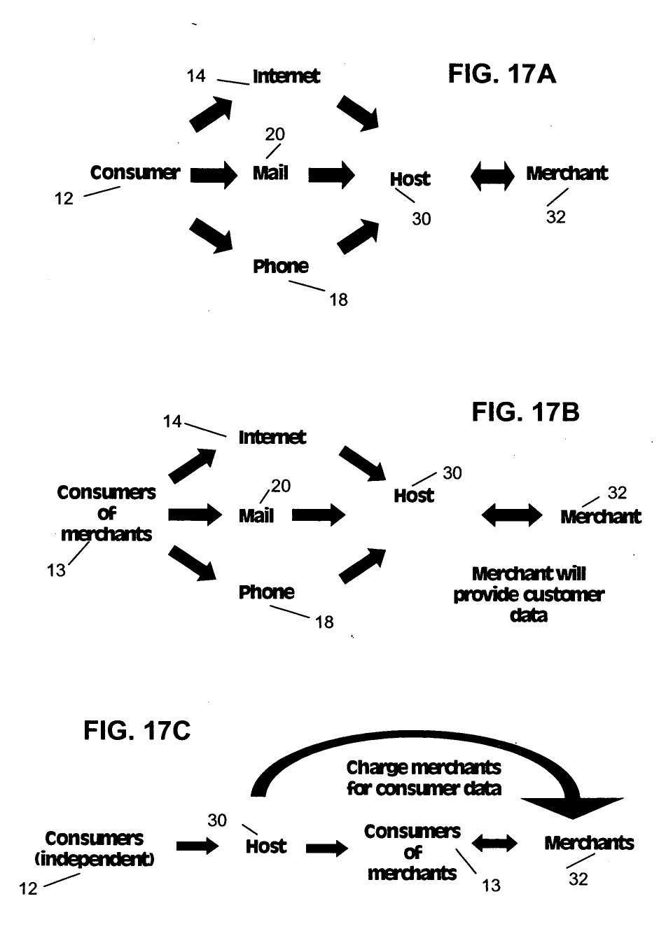

FIG. 17 illustrates three alternate models or embodiments of the present system and method in accordance with FIG. 1 described in detail above. FIG. 17A is a simplified diagram of the embodiment shown in FIG. 1. According to the model in FIG. 17A, consumer preference data is collected by the host 30 from consumer 12, according to the above-described system and method, and then distributed to the merchants 32 for a fee.

FIG. 17B is a variation of the model in FIG. 17A, in that the merchant 32 provides the consumer 12 data, and the host 30, then targets already existing consumers 13 of merchants 32. Once the host 30 targets these particular consumers 12, the targeted consumers 12 submit their consumer preference data to host 30, as described in detail above. The host 30 then distributes the consumer preference data to merchants 32.

FIG. 17C is a hybrid of the models shown in FIGS. 17A and 17B. In FIG. 17C, the host 30 targets both existing consumers 13 of merchants 32 and independent consumers 12. Again, in FIG. 17C, the host 30 charges merchants 32 for both consumer preference data of existing consumers 13 and independent consumers 12.

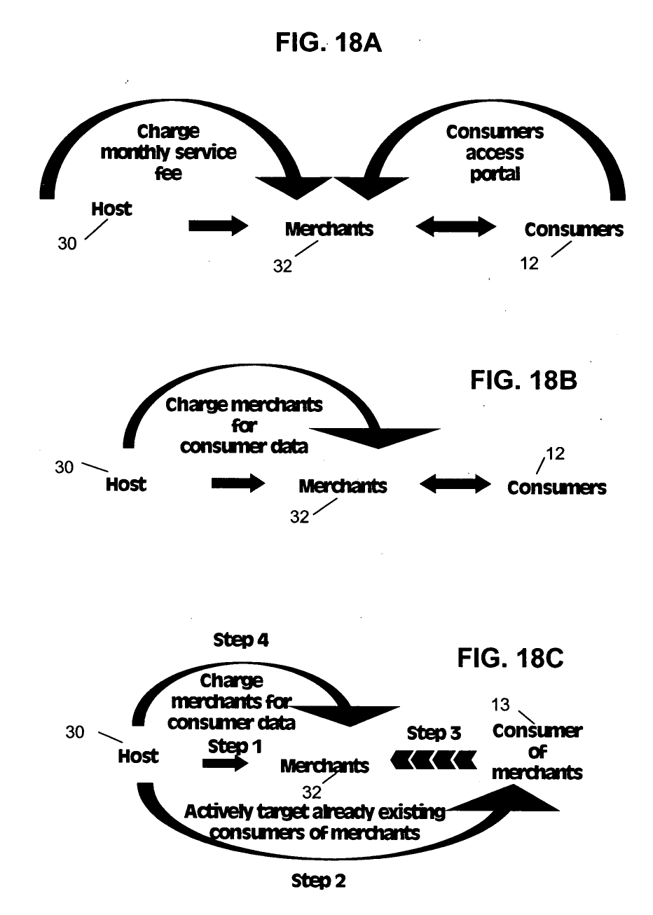

FIG. 18 illustrates three additional alternate models or embodiments of the present system and method. According to the model in FIG. 18A, a portal, as defined above, is sold or licensed to particular merchants 32. The sale and/or license of the portal on the host web site or host 30 is effectuated in numerous ways known in the art, for example, by charging a monthly service fee for use of the portal. The portal then manifests itself as the merchants web site, allowing consumers 12 to access the host 30 and communicate their preferences directly with the merchant 32 according to the method described above. Companies such as Emergent, which distributes catalogs for numerous merchants, would be a primary example of a user of this embodiment.

FIG. 18B is a variation of the model described in FIG. 18A. According to the model in FIG. 18B, the portal is sold or licensed by host 30 to merchants 32, but instead of charging a monthly fee, for example, for supporting the portal 30, the host 30 charges a fee to the merchant 32 for the consumer preference data. Finally, according to the model shown in FIG. 18C, the host 30 sells or licenses a portal to merchant 32, as in FIG. 18B; however, the host 30 also actively targets the already existing consumers 13 of merchants 32, and charges the merchant 32 for the consumer preference data.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

1. A method for capturing business-to-recipient communication preferences, comprising:
providing to a recipient an array of possible communications from businesses, wherein the recipient is prompted to designate communication preferences, wherein the preferences include designations of communications the recipient wants to receive and designations of communications the recipient does not want to receive; and
communicating the preferences to the businesses, wherein the businesses are capable of reacting to the preferences in a manner consistent with the recipient's designations.

2. The method of claim 1, wherein the communication is selected from a group consisting of mail, email, telephone calls, and text messages.

3. The method of claim 1, wherein the communication is selected from a group consisting of catalogs, direct mail solicitations, bulk mail, credit offers, sweepstakes, and loose-leaf fliers.

4. The method of claim 1, wherein the array is in a form selected from a group consisting of an Internet web site, a paper form, an oral reading, and a text message.

5. The method of claim 1, wherein the designations are selected from a group consisting of subject matter, business name, title, frequency and format.

6. The method of claim 1, wherein reacting to the preferences includes terminating the designated communications.

7. The method of claim 1, wherein the recipient receives an incentive for designating communication preferences.

8. A computer-readable storage medium containing computer executable code for instructing a server computer to perform the steps of:
providing to a recipient an array of possible communications from businesses, wherein the recipient is prompted to designate communication preferences, wherein the preferences include designations of communications the recipient wants to receive and designations of communications the recipient does not want to receive; and
storing the preferences, wherein the preferences are capable of being communicated to the businesses, and wherein the businesses are capable of reacting to the preferences in a manner consistent with the recipient's designations.

9. The computer-readable storage medium of claim 8, further containing computer executable code for instructing a server computer to generate an invoice for the preferences communicated to the businesses.

10. The computer-readable storage medium of claim 8, further containing computer executable code for instructing a server computer to generate a request based on the recipient's preferences, wherein the request is capable of being communicated to the businesses.

11. The computer-readable storage medium of claim 10, further containing computer executable code for instructing a server computer to electronically computer the request to the businesses.

12. A system for reducing unsolicited business to consumer mail comprising:
a host server computer including a web site having one or more content-based web pages and in communication with one or more distribution mediums, wherein, in response to a communication from a recipient computer, said host server provides said recipient computer an array of possible communications from businesses, wherein said recipient computer is operable by a recipient and wherein said recipient computer is capable of designating communication preferences, wherein the preferences include designations of communications the recipient wants to receive and designations of communications the recipient does not want to receive; and wherein said host server is capable of communicating the preferences to the businesses, and wherein the businesses are capable of reacting to the preferences in a manner consistent with the recipient's designations.

13. The system of claim 12, further comprising, a business computer, in communication with one or more distribution mediums, wherein the business computer in response to a communication from the host server computer, directs said business computer to execute one or more functions in response to the communication.

14. The system of claim 12, further comprising a recipient computer in communication with one or more distribution mediums, wherein the host server computer in response to a communication from the consumer computer directs said consumer computer to designate communication preferences.

15. A method for providing a business with a targeted consumer list, comprising:
providing to a consumer an array of possible communications from a business, wherein the consumer is prompted to designate communication preferences, wherein the preferences include designations of communications the consumer wants to receive from the business;
communicating to the business the preferences of the consumer, wherein the business is capable of reacting to the preferences by communicating with the consumer in a manner consistent with the consumer designations.

16. The method of claim 15, wherein the business is charged a fee for the preferences of the consumer.

17. The method of claim 15, wherein the business is capable of advertising in proximity to the array.

18. The method of claim 15, wherein the array is visualized by accessing a host web site.

19. The method of claim 18, wherein the business is capable of having a portal on the host web site.

20. The method of claim 15, wherein the consumer is an existing recipient of the business' communications.
